(19) United States
(12) Patent Application Publication
(10) Pub. No.: US 2007/0037909 A1
(43) Pub. Date: Feb. 15, 2007

(54) Diamondoid-based nucleating agents for thermoplastics

(75) Inventors: Steven F. Sciamanna, Orinda, CA (US); Shenggao Liu, Hercules, CA (US); Atsuhiko Mukai, Sagamihara City (JP)

Correspondence Address: BUCHANAN, INGERSOLL & ROONEY PC, POST OFFICE BOX 1404, ALEXANDRIA, VA, 22313-1404, US

(73) Assignee: Chevron U.S.A. Inc., San Ramon, CA (US)

(21) Appl. No.: 11/501,928

(22) Filed: Aug. 8, 2006

Related U.S. Application Data
(60) Provisional application No. 60/706,754, filed on Aug. 10, 2005.
(60) Provisional application No. 60/783,200, filed on Mar. 15, 2006.

(51) Int. Cl. C08K 5/09

(52) U.S. Cl. 524/285

(57) ABSTRACT

The present invention relates to diamondoids and diamondoids derivatives as nucleating agents in the manufacture of thermoplastics. The use of diamondoids and diamondoid derivatives as nucleating agents can increase the overall rate of crystallization of thermoplastics and may lead to a reduction of cycle-time in molding processes and generally to increased output as well. Further, performance characteristics, such as, for example, clarity, stiffness, impact properties, hardness, and heat resistance, may be improved in thermoplastic articles formed from thermoplastics containing diamondoids as nucleating agents.

### CROSS REFERENCE TO RELATED APPLICATIONS

This application claims priority to U.S. Provisional Application Ser. Nos. 60/706,754 filed Aug. 10, 2005, and 60/783,200 filed Mar. 15, 2006, the disclosures of which are incorporated herein by reference in their entirety.

### FIELD OF THE INVENTION

Disclosed is the use of diamondoids and diamondoid derivatives as nucleating agents in the manufacture of thermoplastics.

### DESCRIPTION OF THE RELATED ART

Thermoplastics, such as polypropylene and polyethylene terephthalate, may comprise amorphous and crystalline regions. Phase transformation of thermoplastics crystallizing from a melt begins with the formation of small nuclei, which grow and form spherical macrostructures called spherulites. The number and size of the spherulites affect the texture, optical and mechanical properties of the bulk material.

In the manufacturing process of thermoplastics, a variety of additives are combined with the melt to improve performance characteristics and processability of formed components. One such class of additives is nucleating agents or nucleators.

Polymer nucleating agents are often included in crystalline thermoplastics. These nucleating agents act as nucleating sites for initiating polymer crystallization. Accordingly, the use of nucleating agents leads to higher nucleus number density, allowing for the formation of a larger number of spherulites during the cooling of the melt. In non-nucleated thermoplastics the spherulites are typically less numerous and larger. Smaller spherulites scatter less light, so polymer clarity increases.

One purpose of nucleating agents is to increase the overall rate of crystallization of thermoplastics. A higher crystallization rate ensures a faster solidification of the molten polymer upon cooling. Crystallization temperatures are also often increased by nucleating agents. Higher crystallization rates and higher crystallization temperatures lead to a reduction of cycle-time in melt processing, thus increasing production. Another purpose of nucleating agents is to improve performance characteristics, such as stiffness, impact strength, hardness and heat resistance.

Many different materials, both organic and inorganic, are known to function as polymer nucleating agents. Examples of materials typically used as nucleating agents for polypropylene include talc, salts of benzoic acid, organo-phosphate salts, organic derivatives of dibenzylidene sorbitol (DBS), norbornane carboxylate salts and proprietary compounds.

Thermoplastics are utilized in a variety of end-use applications, including storage containers, medical devices, food packages, plastic tubes and pipes, shelving units, and the like. Since thermoplastics are high volume commodity materials, it is desirable to minimize the concentration of nucleating agents needed in the thermoplastics to minimize the cost, while achieving the same performance objectives.

Nucleating agents for thermoplastics and methods of nucleating thermoplastics that are both effective and economical continue to be needed.

### SUMMARY OF THE INVENTION

Provided is a method of crystallizing a thermoplastic from a melt comprising adding one or more diamondoids or diamondoid derivatives to the melt and crystallizing the thermoplastic from the melt. Further provided is a nucleating agent for use in the crystallization of thermoplastics comprising one or more diamondoids or diamondoid derivatives. Also provided is a thermoplastic article comprising a thermoplastic and one or more diamondoids or diamondoid derivatives. Additionally provided is a process for preparing a nucleating agent comprising providing a diamondoid carboxylic acid derivative and mixing the diamondoid carboxylic acid derivative with a basic solution of a Group I or Group II metal to provide a diamondoid carboxylate salt.

### BRIEF DESCRIPTION OF THE DRAWINGS

FIG. 1 relates to Example 1 and shows the infrared radiation (IR) spectra of Sodium 1-Adamantanecarboxylate and 1-Adamantanecarboxylic acid.

FIGS. 2-6 relate to Example 2. Specifically, FIG. 2 shows a GC-MS (Gas Chromatograph and Mass Spectrometer) total ion chromatogram (TIC) and mass spectrum of 1-hydroxydiamantane (Diamantane-1-ol),

FIG. 3 shows a proton nuclear magnetic resonance (¹H-NMR) spectrum of 1-hydroxydiamantane (Diamantane-1-ol),

FIG. 4 shows a carbon-13 nuclear magnetic resonance (¹³C-NMR) spectrum of 1-hydroxydiamantane (Diamantane-1-ol),

FIG. 5 shows the IR spectrum of 1-diamantanecarboxylic acid, and

FIG. 6 shows the IR spectra of sodium-1-diamantanecarboxylate.

FIG. 7 relates to Example 3 and shows differential scanning calorimetry (DSC) scan results for polypropylene without nucleating agent, polypropylene containing 1200 ppm sodium benzoate, polypropylene containing 1200 ppm sodium-1-adamantanecarboxylate, and polypropylene containing 1200 ppm sodium-1 -diamantanecarboxylate.

### DESCRIPTION OF PREFERRED EMBODIMENTS

It has been surprisingly discovered that diamondoids and diamondoid derivatives are capable of and extremely efficient at nucleating thermoplastics at concentrations in the range of 10 ppmw to 10 wt %. As such, the diamondoids and diamondoid derivatives promote crystallization of molten thermoplastic resins and may provide improved processing characteristics and improved performance characteristics and optical properties.

In the following discussion diamondoids will first be defined, followed by a description of how they may be recovered from petroleum feedstocks. After recovery the diamondoids may be used directly as nucleating agents for thermoplastics as described herein or may be derivatized to provide diamondoid derivatives for use as nucleating agents for thermoplastics.

Diamondoids

The term “diamondoids” refers to substituted and unsubstituted caged compounds of the adamantane series including adamantane, diamantane, triamantane, tetramantane, pentamantane, hexamantane, heptamantane, octamantane, nonamantane, decamantane, undecamantane, and the like, including all isomers and stereoisomers thereof. The compounds have a “diamondoid” topology, which means their carbon atom arrangement is superimposable on a fragment of an FCC diamond lattice. Substituted diamondoids comprise from 1 to 10 and preferably 1 to 4 independently-selected alkyl substituents. Diamondoids include “lower diamondoids” and “higher diamondoids,” as these terms are defined herein, as well as mixtures of any combination of lower and higher diamondoids. Both lower diamondoids and higher diamondoids are useful as nucleating agents as disclosed herein.

The term “lower diamondoids” refers to adamantane, diamantane and triamantane and any and/or all unsubstituted and substituted derivatives of adamantane, diamantane and triamantane. These lower diamondoid components show no isomers or chirality. Adamantane is commercially available from Sigma Aldrich and can be readily synthesized by techniques known in the art. It is also possible to synthesize diamantane and diamantane is available from Lachema s.r.o. (Brno, Czech Republic) and TCI Amercia (Boston, Mass.). Triamantane may be synthesized by techniques as described in Williams, Jr., Van Zandt, et al., “Triamantane,” Journal of the American Chemical Society, 88(16), 3862-3863 (1966).

Adamantane chemistry has been reviewed by Fort, Jr. et al. in “Adamantane: Consequences of the Diamondoid Structure,” Chem. Rev. vol. 64, pp. 277-300 (1964). Adamantane is the smallest member of the diamondoid series and may be thought of as a single cage crystalline subunit. Diamantane contains two subunits, triamantane three, tetramantane four, and so on. While there is only one isomeric form of adamantane, diamantane, and triamantane, there are four different isomers of tetramantane (two of which represent an enantiomeric pair), i.e., four different possible ways of arranging the four adamantane subunits. The number of possible isomers increases non-linearly with each higher member of the diamondoid series, pentamantane, hexamantane, heptamantane, octamantane, nonamantane, decamantane, etc.

Adamantane, which is commercially available, has been studied extensively. The studies have been directed toward a number of areas, such as thermodynamic stability, functionalization, and the properties of adamantane-containing materials. For instance, the following patents discuss materials comprising adamantane subunits: U.S. Pat. No. 3,457,318 teaches the preparation of polymers from alkenyl adamantanes; U.S. Pat. No. 3,832,332 teaches a polyamide polymer forms from alkyladamantane diamine; U.S. Pat. No. 5,017,734 discusses the formation of thermally stable resins from adamantane derivatives; and U.S. Pat. No. 6,235,851 reports the synthesis and polymerization of a variety of adamantane derivatives.

The term “higher diamondoids” refers to any and/or all substituted and unsubstituted tetramantane components; to any and/or all substituted and unsubstituted pentamantane components; to any and/or all substituted and unsubstituted hexamantane components; to any and/or all substituted and unsubstituted heptamantane components; to any and/or all substituted and unsubstituted octamantane components; to any and/or all substituted and unsubstituted nonamantane components; to any and/or all substituted and unsubstituted decamantane components; to any and/or all substituted and unsubstituted undecamantane components; as well as mixtures of the above and isomers and stereoisomers of tetramantane, pentamantane, hexamantane, heptamantane, octamantane, nonamantane, decamantane, and undecamantane.

The four tetramantane structures are iso-tetramantane [1(2)3], anti-tetramantane [121] and two enantiomers of skew-tetramantane [123], with the bracketed nomenclature for these diamondoids in accordance with a convention established by Balaban et al. in “Systematic Classification and Nomenclature of Diamond Hydrocarbons-I,” Tetrahedron vol. 34, pp. 3599-3606 (1978). All four tetramantanes have the formula C₂₂H₂₈ (molecular weight 292).

There are ten possible pentamantanes, nine having the molecular formula C₂₆H₃₂ (molecular weight 344) and among these nine, there are three pairs of enantiomers represented generally by [12(1)3], [1234], [1213] with the nine enantiomeric pentamantanes represented by [12(3)4], [1(2,3)4], [1212]. There also exists a pentamantane [1231] represented by the molecular formula C₂₅H₃₀ (molecular weight 330).

Hexamantanes exist in thirty-nine possible structures with twenty eight having the molecular formula C₃₀H₃₆ (molecular weight 396) and of these, six are symmetrical; ten hexamantanes have the molecular formula C₂₉H₃₄ (molecular weight 382) and the remaining hexamantane [12312] has the molecular formula C₂₆H₃₀ (molecular weight 342).

Heptamantanes are postulated to exist in 160 possible structures with 85 having the molecular formula C₃₄H₄₀ (molecular weight 448) and of these, seven are achiral, having no enantiomers. Of the remaining heptamantanes 67 have the molecular formula C₃₃H₃₈ (molecular weight 434), six have the molecular formula C₃₂H₃₆ (molecular weight 420) and the remaining two have the molecular formula C₃₀H₃₄ (molecular weight 394).

Octamantanes possess eight of the adamantane subunits and exist with five different molecular weights. Among the octamantanes, 18 have the molecular formula C₃₄H₃₈ (molecular weight 446). Octamantanes also have the molecular formula C₃₈H₄₄ (molecular weight 500); C₃₇H₄₂ (molecular weight 486); C₃₆H₄₀ (molecular weight 472), and C₃₃H₃₆ (molecular weight 432).

Nonamantanes exist within six families of different molecular weights having the following molecular formulas: C₄₂H₄₈ (molecular weight 552), C₄₁H₄₆ (molecular weight 538), C₄₀H₄₄ (molecular weight 524, C₃₈H₄₂ (molecular weight 498), C₃₇H₄₀ (molecular weight 484) and C₃₄H₃₆ (molecular weight 444).

Decamantane exists within families of seven different molecular weights. Among the decamantanes, there is a single decamantane having the molecular formula C₃₅H₃₆ (molecular weight 456) which is structurally compact in relation to the other decamantanes. The other decamantane families have the molecular formulas: C₄₆H₅₂ (molecular weight 604); C₄₅H₅₀ (molecular weight 590); C₄₄H₄₈ (molecular weight 576); C₄₂H₄₆ (molecular weight 550); C₄₁H₄₄ (molecular weight 536); and C₃₈H₄₀ (molecular weight 496).

Undecamantane exists within families of eight different molecular weights. Among the undecamantanes there are two undecamantanes having the molecular formula C₃₉H₄₀ (molecular weight 508) which are structurally compact in relation to the other undecamantanes. The other undecamantane families have the molecular formulas C₄₁H₄₂ (molecular weight 534); C₄₂H₄₄ (molecular weight 548); C₄₅H₄₈ (molecular weight 588); C₄₆H₅₀ (molecular weight 602); C₄₈H₅₂ (molecular weight 628); C₄₉H₅₄ (molecular weight 642); and C₅₀H₅₆ (molecular weight 656).

Isolation of Diamondoids from Petroleum Feedstocks

As provided above, adamantane is commercially available and may be readily synthesized and diamantane may be purchased, as well as synthesized.

Diamondoids may also be isolated from certain hydrocarbon feedstocks. Feedstocks that contain recoverable amounts of diamondoids, including higher diamondoids, include, for example, natural gas condensates and refinery streams resulting from cracking, distillation, coking processes, and the like. Particularly preferred feedstocks originate from the Norphlet Formation in the Gulf of Mexico and the LeDuc Formation in Canada.

These feedstocks contain large proportions of lower diamondoids (often as much as about two thirds) and lower but significant amounts of higher diamondoids (often as much as about 0.3 to 0.5 percent by weight). The processing of such feedstocks to remove non-diamondoids and to separate higher and lower diamondoids (if desired) can be carried out using, by way of example only, size separation techniques such as membranes, molecular sieves, etc., evaporation and thermal separators either under normal or reduced pressures, extractors, electrostatic separators, crystallization, chromatography, well head separators, and the like.

A preferred separation method typically includes distillation of the feedstock. The distillation can remove low-boiling, non-diamondoid components. It can also separate the lower and higher diamondoid components. In either instance, the lower cuts will be enriched in lower diamondoids and low boiling point non-diamondoid materials. Distillation can be operated to provide several cuts in the temperature range of interest to provide the initial isolation of the identified diamondoid. The cuts, which are enriched in higher diamondoids or the diamondoid of interest, are retained and may require further purification. Other methods for the removal of contaminants and further purification of an enriched diamondoid fraction can additionally include the following nonlimiting examples: size separation techniques, evaporation either under normal or reduced pressure, sublimation, crystallization, chromatography, well head separators, flash distillation, fixed and fluid bed reactors, reduced pressure, and the like.

The removal of non-diamondoids may also include a pyrolysis step either prior or subsequent to distillation. Pyrolysis is an effective method to remove hydrocarbonaceous, non-diamondoid components from the feedstock. It is effected by heating the feedstock under vacuum conditions, or in an inert atmosphere, to a temperature of at least about 390° C., and most preferably to a temperature in the range of about 410 to 450° C. Pyrolysis is continued for a sufficient length of time, and at a sufficiently high temperature, to thermally degrade at least about 10 percent by weight of the non-diamondoid components that were in the feed material prior to pyrolysis. More preferably at least about 50 percent by weight, and even more preferably at least 90 percent by weight of the non-diamondoids are thermally degraded.

While pyrolysis is preferred in one embodiment, it is not always necessary to facilitate the recovery, isolation or purification of diamondoids. Other separation methods may allow for the concentration of diamondoids to be sufficiently high given certain feedstocks such that direct purification methods such as chromatography including preparative gas chromatography and high performance liquid chromatography, crystallization, and fractional sublimation may be used to isolate diamondoids.

Even after distillation or pyrolysis/distillation, further purification of the material may be desired to provide selected diamondoids for use in the compositions employed in this invention. Such purification techniques include chromatography, crystallization, thermal diffusion techniques, zone refining, progressive recrystallization, size separation, and the like. For instance, in one process, the recovered feedstock is subjected to the following additional procedures: 1) gravity column chromatography using silver nitrate impregnated silica gel; 2) two-column preparative capillary gas chromatography to isolate diamondoids; 3) crystallization to provide crystals of the purified diamondoids.

An alternative process is to use single or multiple column liquid chromatography, including high performance liquid chromatography, to isolate the diamondoids of interest. As above, multiple columns with different selectivities may be used. Further processing using these methods allow for more refined separations which can lead to a substantially pure component.

Detailed methods for processing feedstocks to obtain higher diamondoid compositions are set forth in U.S. Pat. No. 6,844,477 issued Jan. 18, 2005; U.S. Pat. No. 6,815,569 issued Nov. 9, 2004; and U.S. patent application Ser. No. 11/013,638 filed Dec. 17, 2004, published on Jul. 21, 2005 as publication number US-2005-0159634-A1. These applications are herein incorporated by reference in their entirety.

Derivatization

After the diamondoids are obtained by purchasing commercially, synthesizing, or isolating from feedstocks, the diamondoid materials may be derivatized by the addition of functional groups.

Methods of forming diamondoid derivatives are discussed in U.S. patent application Ser. No. 10/313,804 filed on Dec. 6, 2002, and U.S. patent application Ser. No. 10/046,486 filed on Jan. 16, 2002 and issued as U.S. Pat. No. 6,858,700 on Feb. 22, 2005, and both herein incorporated by reference in their entirety.

As discussed in those applications, there are two major reaction sequences that may be used to derivatize higher diamondoids: nucleophilic (S_{N}1-type) and electrophilic (S_{E}2-type) substitution reactions.

S_{N}1-type reactions involve the generation of higher diamondoid carbocations, which subsequently react with various nucleophiles. Since tertiary (bridgehead) carbons of higher diamondoids are considerably more reactive then secondary carbons under S_{N}1 reaction conditions, substitution at a tertiary carbon is favored.

S_{E}2-type reactions involve an electrophilic substitution of a C—H bond via a five-coordinate carbocation intermediate. Of the two major reaction pathways that may be used for the functionalization of higher diamondoids, the S_{N}1-type may be more widely utilized for generating a variety of higher diamondoid derivatives. Mono and multi-brominated higher diamondoids are some of the most versatile intermediates for functionalizing higher diamondoids. These intermediates are used in, for example, the Koch-Haaf, Ritter, and Friedel-Crafts alkylation and arylation reactions. Although direct bromination of higher diamondoids is favored at bridgehead (tertiary) carbons, brominated derivatives may be substituted at secondary carbons as well. For the latter case, when synthesis is generally desired at secondary carbons, a free radical scheme is often employed.

Although the reaction pathways described above may be preferred in some embodiments of the present invention, many other reaction pathways may certainly be used as well to functionalize a diamondoid. These reaction sequences may be used to produce derivatized diamondoids having a variety of functional groups, such that the derivatives may include diamondoids that are halogenated with elements other than bromine, such as fluorine, alkylated diamondoids, nitrated diamondoids, hydroxylated diamondoids, carboxylated diamondoids, ethenylated diamondoids, and aminated diamondoids. Table 1 below lists exemplary substituents that may be attached to diamondoids to provide derivatives.

TABLE 1
Diamondoid Derivatives

| DIAMONDOID | SUBSTITUENT |
|---|---|
| adamantane - undecamantane | F |
| adamantane - undecamantane | Cl |
| adamantane - undecamantane | Br |
| adamantane - undecamantane | I |
| adamantane - undecamantane | OH |
| adamantane - undecamantane | CO₂H |
| adamantane - undecamantane | CO₂CH₂CH₃ |
| adamantane - undecamantane | COCl |
| adamantane - undecamantane | SH |
| adamantane - undecamantane | CHO |
| adamantane - undecamantane | CH₂OH |
| adamantane - undecamantane | NH₂ |
| adamantane - undecamantane | NO₂ |
| adamantane - undecamantane | ═O (keto) |
| adamantane - undecamantane | CH═CH₂ |
| adamantane - undecamantane | C≡CH |
| adamantane - undecamantane | C₆H₅ |
| adamantane - undecamantane | NHCOCH₃ |
| adamantane - undecamantane | NHCHO |

In one aspect of the invention, when used as nucleating agents the diamondoids and diamondoid derivatives optimally should have the following characteristics at the maximum thermoplastic melt processing temperature: a low solubility in the thermoplastic; melting point and a decomposition temperature that is higher than the melt processing temperature; and a low vapor pressure. A nucleating agent with these characteristics will remain intact as a dispersed solid phase in the thermoplastic melt to serve as a site of heterogeneous nucleation for thermoplastic crystallization.

In another aspect, the diamondoid and diamondoid derivatives are soluble in the thermoplastic melt. Such a nucleating agent can act as a clarifier in the thermoplastic composition.

Since diamondoids are hydrocarbons, they have good solubility in a variety of hydrocarbon solvents, such as, for example, heptane, cyclohexane and toluene. The solubility of diamondoids in such solvents may increase with increasing temperature. Accordingly, they may be somewhat soluble in a thermoplastic melt, such as a polypropylene melt, which is essentially a highly viscous hydrocarbon liquid. To minimize the solubility, the diamondoids may be derivatized with functional groups that will reduce their solubility. In addition, the concentration of the diamondoid or diamondoid derivative may be adjusted such that the diamondoid or diamondoid derivative is present in sufficient quantity to exceed its solubility limit in the thermoplastic at the melt temperature. The solubility of a solid solute in a liquid solvent is dependent, at least in part, on the melting point temperature of the solid solute. Above the melting point temperature of the solid solute, it changes from a solid to a liquid phase and may become all, or partially, miscible in the solvent. Diamondoids and diamond derivatives also exhibit this behavior. In addition, there are some solid solutes that do not melt but rather decompose. Decomposing is also an undesirable characteristic of a thermoplastic nucleator. Diamondoids and diamondoid derivatives used as a nucleator in thermoplastic melt preferably should have a melting point and decomposition temperature greater than the maximum melt temperature. Advantageously, the diamondoids and diamondoid derivatives can readily be uniformly distributed throughout the thermoplastic melt.

When used as nucleating agents, the diamondoids and diamondoid derivatives need low enough vapor pressures so that their composition does not change while mixing the thermoplastic melt since the thermoplastic melt in which they are to be used may be held at an elevated temperature, for example at 180-200° C., for an appreciable amount of time, for example 1 hr. Lower diamondoids and higher diamondoids span a wide range of vapor pressures. At one end of the spectrum, solid adamantane sublimes at room temperature, while tetramantanes have Atmospheric Equivalent Boiling Points of 355-371° C. At a melt temperature of 180° C., the vapor pressures of adamantane and diamantane are 300 mm Hg and 40 mm Hg, respectively. As a result of these elevated vapor pressures, adamantane and diamantane cannot be retained in a polymer melt for an extended period of time unless the melt is maintained under pressure. Although adamantane and diamantane have elevated vapor pressures, they are less expensive than the higher diamondoids and hence appear to be more economically attractive than the higher diamondoids for use as nucleating agents. However, higher diamondoids and diamondoid derivatives have lower vapor pressures and are therefore more attractive for their physical properties.

Thus, in one aspect of the invention, to minimize the vapor pressure the diamondoids may be derivatized with functional groups that will lower their vapor pressure. Increasing the molecular weight of the diamondoid is one way to decrease vapor pressure. However, increasing the molecular weight of a diamondoid to the point where there is a sufficient reduction in vapor pressure often increases the weight concentration of the diamondoid and hence makes its use uneconomical.

Accordingly, it may be desirable to reduce both the vapor pressure and solubility of the diamondoids, specifically the lower diamondoids. Adding oxygen-containing functional groups, such as hydroxyl and carboxylic acid groups, to a diamondoid reduces the solubility and volatility of the diamondoid in a non-polar polymer melt. Furthermore, the solubility and vapor pressure can be significantly decreased by converting the carboxylic acid functionality of a diamondoid-derivative into a salt. As such, the diamondoid carboxylic acid derivatives may be converted into a salt of a Group I, a Group II metal, or any other metal. Accordingly, appropriate nucleating agents include the organic salt of diamondoid carboxylic acid derivatives containing Group I (e.g., lithium, sodium, potassium, rubidium, cesium), Group II metals (e.g., magnesium, calcium, strontium, barium), or other metals (e.g., aluminum, zinc, chromium, manganese, iron, cobalt, nickel, copper).

Mono-carboxylic acid derivatives can be prepared as well as di and tri-carboxylic acid derivatives. These carboxylic acid derivatives readily can be converted to salts of Group I, Group II, and other metals.

In another aspect of the invention, to minimize the vapor pressure a diamondoid-containing nucleating agent may be a compound which has one, two, three or more diamondoid moieties. The diamondoids may be derivatized with functional groups that will further lower their vapor pressure.

When used as nucleating agents according to the present invention, the diamondoids and diamondoid derivatives may increase the crystallization temperature of the polymer and thereby may reduce the cycle time in the forming process. As such, the formed part can be ejected from the mold or forming machine sooner because it has crystallized or hardened and this decreased residence time increases the throughput capacity of the forming process. When used as nucleating agents according to the present invention, the diamondoids and diamondoid derivatives may also improve performance characteristics and physical properties, such as impact strength, hardness, stiffness, temperature resistance, tensile strength and flexural modulus.

When used in thermoplastics, the purpose of clarifying agents is to improve the clarity of a polymer. Clarifying agents are a sub-class of nucleating agents, meaning that all clarifying agents are nucleating agents, while all nucleating agents are not clarifying agents. However, many nucleating agents do provide a significant increase in clarity. The fine fibrous network formed when using clarifying agents contributes to clarity by providing high nucleus density with very small spherulites. Spherulite size is reduced to the point that the spherulites are less than the wavelength of visible light and light is allowed to pass around the spherulites without scattering. Because visible wavelengths are not significantly affected by the small spherulites, the resulting polymer is much more optically clear. The diamondoid and diamondoid derivatives of the present invention may also act as clarifying agents.

Thermoplastics

A “thermoplastic”, or “thermopolymer,” refers to a polymeric material that will soften or melt upon exposure to sufficient heat and can be formed into a shape that will be retained upon sufficient cooling. A thermoplastic will retain this property through several cycles of heating and cooling. Thermoplastics encompass polymers that exhibit crystalline or semi-crystalline morphology upon cooling after melt-formation, as well as amorphous polymers. Many different thermoplastics are known to crystallize to a greater or lesser extent when they solidify.

Suitable thermoplastics for use according to the present invention include any crystalline or amorphous thermoplastics. For example, thermoplastics of the invention include polyolefins, such as polyethylene, polypropylene, polybutylene, and any combination thereof. Suitable polyethylenes include low-density polyethylene (LDPE), linear low-density polyethylene (LLDPE), high-density polyethylene (HDPE) and ultra-high-density polyethylene (UHDPE). In addition, copolymerization of ethylene with polar monomers such as vinyl esters (e.g., vinyl acetate, acrylate esters, carboxylic acids, and vinyl ethers) can be used to adjust crystallinity and modify product properties such as toughness, clarity, gloss, tensile strength, elongation at break, stress cracking resistance, and flexibility at low temperatures Also suitable are polybutylene and polyisobutylene. Poly(4-methyl pentene-1) thermoplastics are also suitable.

Additional suitable thermoplastics for use in the invention include polystyrene, poly(vinyl chloride), polyvinylidene chloride, poly(vinyl fluoride), polyvinylidene fluoride, polytetrafluoroethylene, polychlorotrifluoroethylene, poly(vinyl acetate), poly(vinyl alcohol), polylactic acid, polyacetal (polyoxymethylene), polyphenylene sulfide, polyphenylene oxide, polycarbonate, polysulfones, polyimides, ionomers, acrylonitrile-butadiene-styrene terpolymers (ABS), polyether ether ketone (PEEK), polyurethanes, syndiotactic polystyrene liquid crystal polymers, polyacrylates and polymethacrylates, including poly(methacrylate), poly(methyl methacrylate), polyacrylate, poly(methyl acrylate), poly(ethyl acrylate), poly(propyl acrylate), poly(butyl acrylate), poly(2-ethylhexyl acrylate), poly(itaconate), poly(dimethylaminoethyl methacrylate), poly(2-hydroxyethyl acrylate), poly(N-hydroxyethyl acrylamide), and poly(glycidyl methacrylate); polyesters, including polyethylene terephthalate, polybutylene terephthalate, polyethylene naphthalate (such as that formed from ethylene glycol and 2,6-naphthalene dicarboxylic acid); and polyamides, including the aliphatic polyamides such as nylon 6, nylon 6,6, nylon 6,8, nylon 6,9, nylon 6,10, nylon 6,12, nylon 4, nylon 7, nylon 11, nylon 12, the aramids such as polyterephthalamide, poly(m-phenyleneisophthalamide)(Nomex) and poly(p-phenylene terephthalamide)(Kevlar), and mixed aliphatic-aromatic polyamides such as Polyamide 6T and Polyamide 9T. Any combination of thermoplastics is also suitable for use in the invention. Also, the thermoplastics may be in isotactic, syndiotactic or atactic forms, depending upon the characteristics of the particular thermoplastic.

Thermoplastic Compositions and Processing

The diamondoids and/or diamondoid derivates are incorporated in a nucleating effective amount during compounding or processing of thermoplastics. This incorporation can be effected by a variety of means to insure uniform distribution of the nucleating agent throughout the thermoplastic. One such means is by use of an intense mechanical mixing device. This is the most common means of incorporation on an industrial scale. Another means of incorporation is to dissolve the diamondoids or diamondoid derivatives in a solvent which is easily mixed with a thermoplastic in a powder or flake form. The solvent is chosen such that it vaporizes prior to the maximum melt temperature and preferably prior to the glass transition temperature (Tg) of the thermoplastic thus providing uniform distribution of the nucleator throughout the thermoplastic. Additional mechanical mixing can be provided before or after melting of the thermoplastic. For example, the sodium salt of a diamondoid carboxylate to be incorporated may be dissolved in a solution of ethanol and water. This solution is uniformly mixed with thermoplastic flake or powder forming a paste. The water/ethanol solvent is then evaporated from the paste resulting in a uniform dispersion of nucleator throughout the thermoplastic. Any method will suffice that achieves the uniform mixing of small amounts of one material in a large amount of another. Any solvent or solvent mixture is suitable that when mixed with the diamondoid carboxylate salt nucleator provides sufficient solvating power to dissolve the requisite amount of nucleator.

A “nucleating effective amount” refers to the amount of nucleating agent required to increase the overall rate of crystallization of thermoplastics. Differential Scanning Calorimetry is typically utilized to indicate a nucleating agent's efficacy. In particular, the nucleating effective amount is the amount of nucleating agent required to increase the peak crystallization temperature (T_{c}) greater than the value of T_{c} for polypropylene without nucleating agent. The nucleating effective amount, and thus, the concentration, of diamondoids and/or derivates of diamondoids is about 10 ppmw to 10 wt %.

Additional plastic additives can be added as desired to the thermoplastic. Plastic additives include modifiers, processing aids, and property extenders. Accordingly, additional modifiers can be added to the thermoplastic according to the present invention, including, for example, plasticizers, chemical blowing agents, coupling agents, impact modifiers, and organic peroxides. Additionally, property extenders can be added to the thermoplastic according to the present invention, including, for example, flame retardants, heat stabilizers, antioxidants, light stabilizers, biocides, and antistatic agents. Moreover, processing aids can be added to the thermoplastic according to the present invention, including, for example, lubricants, slip agents, mold release agents, and antiblocking agents may be incorporated. One or more of these additives may be added to the thermoplastic according to the present invention.

For example, a plasticizer may be included in the thermoplastic composition of the invention, such as a phthalate ester, including a dialkylphthalate (e.g., di-2-ethylhexykl phthalate); a phosphate ester, including a trialkyl-phosphate or triaryl-phosphate (e.g., tricresyl phosphate), adipates (e.g., di-2-ethylhexyl adipate), azelates, oleates, sebacates and other aliphatic diesters, glycol derivatives (e.g., dipropyleneglycol benzoate), trimellitates including trialkyltrimellitates (e.g., trisethylhexy trimellitate)

Various fillers may also be included in the compositions of the invention, including calcium carbonate, talc, silica, wollastonite, clay, calcium sulfate, mica, alumina trihydrate, and carbon black. Glass structures, such as roving, mat, hollow or solid spheres, bubbles, long or short fibers and continuous fibers, may be included for reinforcement. Fibers of boron, Kevlar, polybutylene terephthalate, steel or carbon may also be used for reinforcement.

Pigments may also be added to the thermoplastic according to the present invention. When used as nucleating agents according to the present invention, the diamondoids and diamondoid derivatives may reduce the dimensional stability problems, like distortion, warping, or shrinkage, caused by pigments.

Accordingly, in a method of crystallizing a thermoplastic from a melt, one or more diamondoids or diamondoid derivatives may be added to the melt. Optionally, one or more additional additives may be added. The melt is maintained when the temperature of the melt is above the melting point of the thermoplastic and the thermoplastic is crystallized by cooling the melt to a temperature below the melting point of the thermoplastic. In one aspect of the invention, when used as nucleating agents, the diamondoids and diamondoid derivatives promote crystallization of the thermoplastic melt.

Thermoplastic Articles

Provided are articles comprising a thermoplastic and one or more diamondoids or diamondoid derivatives. The thermoplastic articles may be formed by various processing techniques including injection molding, blow molding, thermoforming, and extrusion. Examples of such thermoplastic articles include storage containers, caps and closures, medical devices, food packages, plastic tubes and pipes, and shelving units. In addition, films are often formed from thermoplastics. The thermoplastic articles may be transparent or colored. Polypropylene based materials are greatly utilized in the automobile industry because of their low cost and properties.

The use of diamondoids and diamondoid derivatives as nucleating agents increases the crystallization temperature and may increase the overall rate of crystallization of thermoplastics, leading to a reduction of cycle-time in molding processes and generally to increased output as well. Further, performance characteristics and mechanical properties may be improved in thermoplastic articles formed from thermoplastics containing diamondoids as nucleating agents. These performance characteristics and mechanical properties that may be improved include stiffness, impact properties, hardness, heat resistance, tensile strength, flexural modulus, and the like. This improvement of mechanical properties generally enables downgauging, thinwalling, and weight reduction of the finished parts.

The invention will be further explained by the following illustrative examples that are intended to be non-limiting.

### EXAMPLE 1

### Synthesis of Sodium 1-Adamantanecarboxylate (S-1-A)

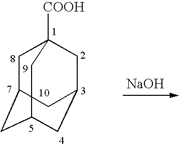

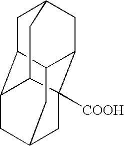

| Reagent | MW | Amount | Moles | Eq. |
|---|---|---|---|---|
| 1-Adamantanecarboxylic acid | 180.25 | 0.892 | 4.944 mmol | 1.0 |
| | | g | | |
| NaOH Water Solution (0.1016 M) | 40.00 | 48.66 | 0.590 mmol | 1.0 |
| | | mL | | |
| Sodium 1-Adamantanecarboxylate | 202.23 | 1.0 g | | 1.0 |

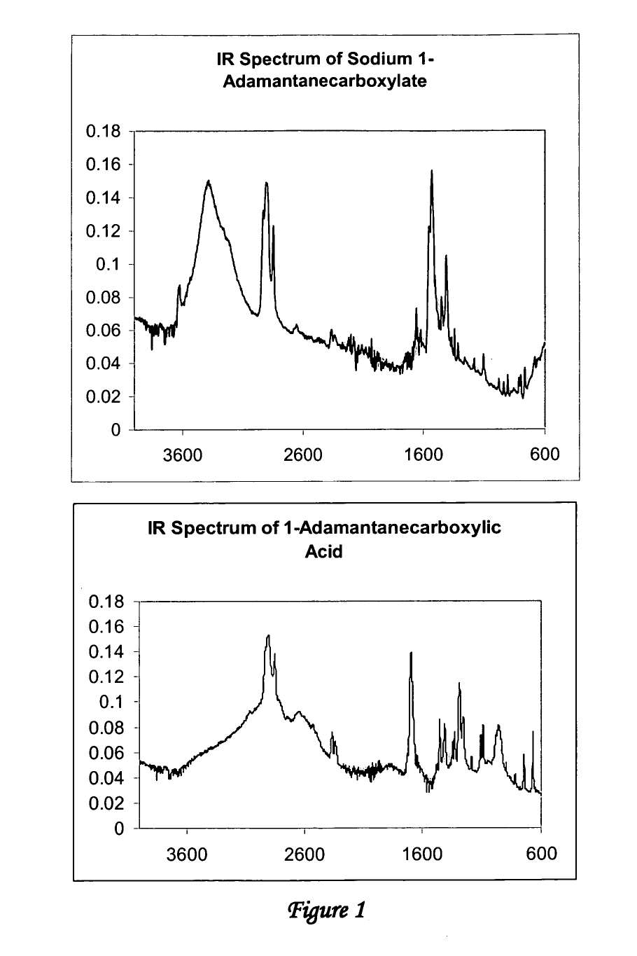

The desired amount of materials was weighed and loaded into a 100 mL round bottom flask. The mixture was stirred at room temperature under nitrogen for 16 hours. The major water solvent was evaporated by rotovap to about 80-90% dryness and then about 500 mL acetone was added to precipitate the salt product. The mixture was allowed to stand and then centrifuged (if not centrifuged, filtration is very difficult). The final solid was dried while rinsing with a minimum amount of acetone under suction with in-house vacuum (0.8788 g, 87.8% yield). FIG. 1 shows the IR spectra of the acid and its sodium salt. In the sodium salt, the C═O stretch was shifted to about 1530 cm⁻¹ from about 1692 cm⁻¹ in the acid.

### EXAMPLE 2

### Synthesis of Sodium 1-Diamantanecarboxylate (S-1-D)

Step 1. Synthesis of 1-bromodiamantane and 1-hydroxydiamantane from Diamantane

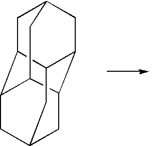

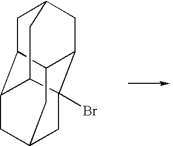

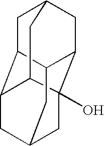

| Reagent | Source/Cat. No. | MW | Amount | Moles | Eq. |
|---|---|---|---|---|---|
| Diamantane | Chevron/2010780 | 188.31 | 4.653 g | 0.0247 | 1.0 |
| Bromine | Aldrich/328138-10G | 159.82 | 9.873 g | | 2.5 |

Secs for bromine: b.p. = 58-59° C., d = 3.11, m.p. = −7.2° C.

The above chemicals were charged to a 50 mL round bottom flask. The mixture was stirred at room temperature for 5 hours and HBr gas (white gas) was generated during the reaction and was treated with NaOH water solution. During the reaction no significan heat was generated. After the reaction was completed, excess bromine was evaporated under vacuum with rotovap to give a light yellowish oily solid mixture. TLC analysis showed one major product in the solids with purity above about 80%. Further purification was achieved by column chromatography on silica gel with cyclohexane and CH₂Cl₂ gradient elution. Further purification can also be achieved by pouring the reaction mixture onto ice or ice water and adding 50 mL CH₂Cl₂ to the ice mixture. The organic layer would be separated and the aqueous layer extracted by CH₂Cl₂ an additional 2-3 times. The organic layers were then combined and washed with aqueous sodium hydrogen carbonate and water, and finally dried. After removing the solvent, 1-bromodiamantane was purified by subjecting it to column chromatography on silica gel using standard elution conditions (e.g., eluting with cyclohexane or its mixtures with ethyl ether).

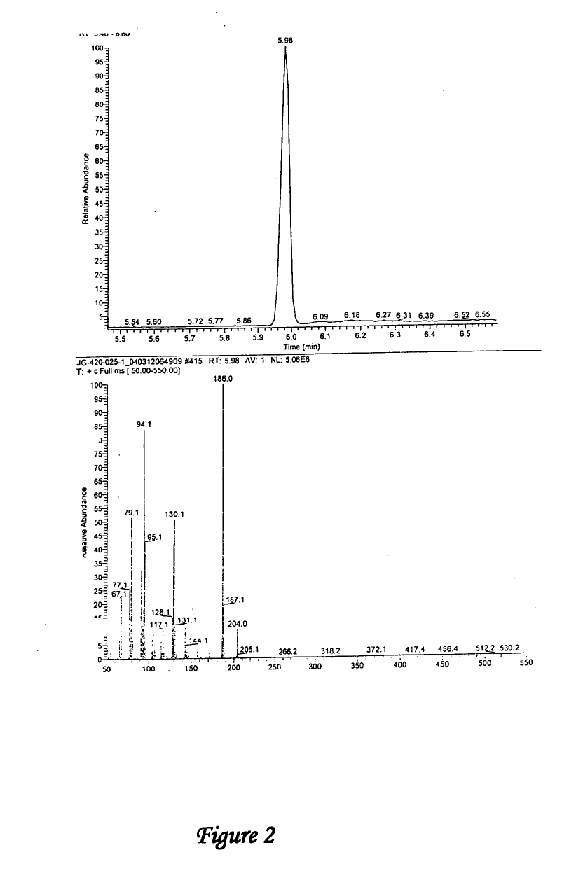

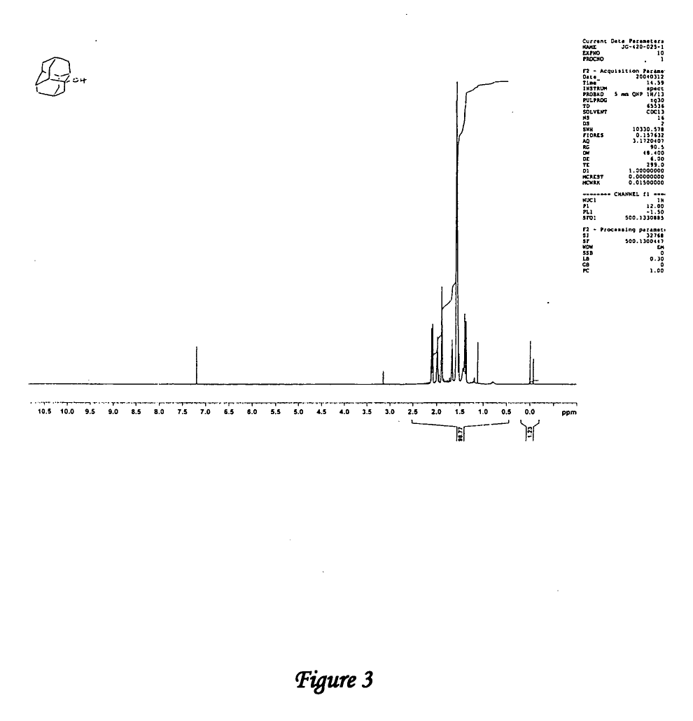

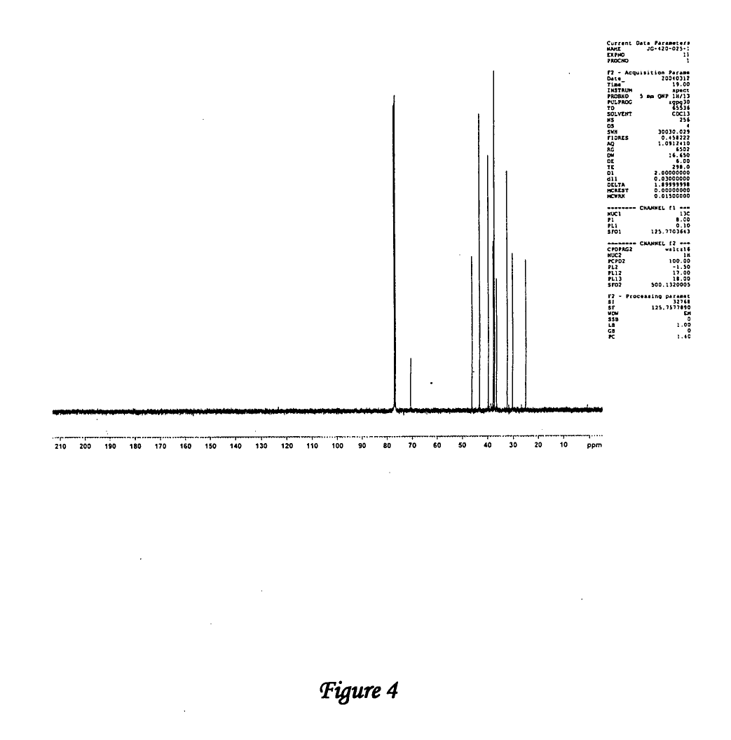

Reaction of the brominated diamantane with hydrochloric acid in dimethylformamide (DMF) converts the compound to the corresponding hydroxylated diamantane with almost quantitative yield.

| | |
|---|---|
| 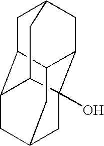 | Analysis of 1-hydroxydiamantane (Diamantane-1-ol) R_{f} = 0.40 (hexane/MTBE, 75:25) GC-MS shown in FIG. 2 ¹H—NMR shown in FIG. 3 ¹³C—NMR shown in FIG. 4 |

Step 2. Synthesis of 1-diamantanecarboxylic acid from 1-hydroxydiamantane or 1-bromodiamantane

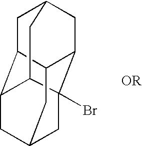

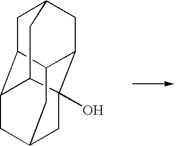

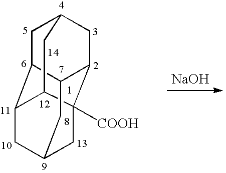

| Reagent | MW | d | Amount | Moles | Eq. |
|---|---|---|---|---|---|
| 1-hydroxydiamantane | 204.313 | | 3.821 g | 0.0187 | 1.0 |
| H₂SO₄ (conc.) | 98.08 | 1.925 | 120 mL | 2.355 | 126 |
| HCOOH (anhydrous) | 46.03 | 1.22 | 8.44 mL | 0.223 | 12 |

Carboxylated diamondoids can be synthesized using the Koch-Haaf reaction, starting with hydroxylated or brominated diamondoids. In most cases, hydroxylated precursors provide better yields than brominated diamondoids.

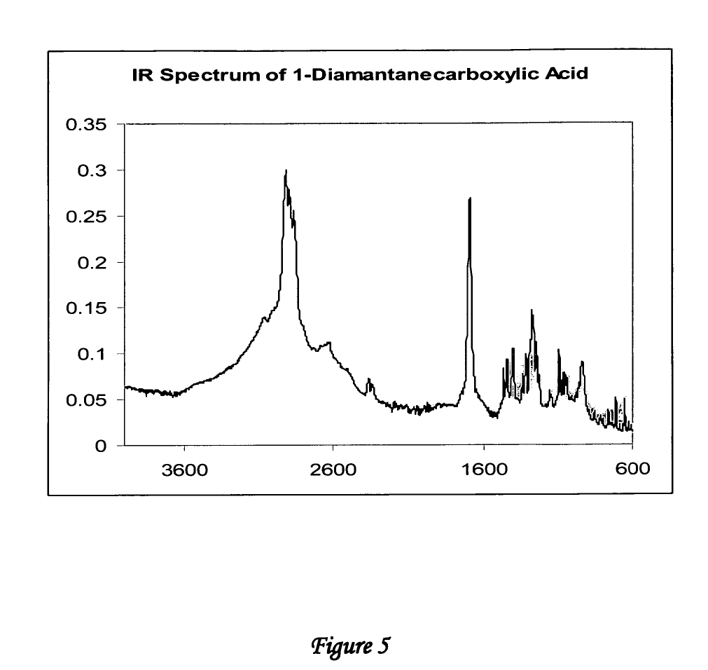

120 mL of concentrated sulfuric acid was placed into a 250-mL three-necked flask, which was equipped with a stirrer, a reflux condenser and an Anschütz top with two dropping funnels. The concentrated sulfuric acid was cooled to 10° C. in an ice bath. After removing the ice bath, while stirring, 1-bromodiamantane (4.98 g) dissolved in 8.3 mL dry, highly pure n-hexane and 8.44 mL anhydrous formic acid was added drop wise into the flask over about 0.5 hour. A fume hood removed carbon monoxide that was produced. The reaction mixture turned reddish brown. After completion of the drop wise addition, the mixture was vigorously stirred for about 2 hours at room temperature. The reaction mixture was poured onto ice and allowed to stand for about 2 hours, during which time the acid precipitated out. The acid was then purified by dissolution in ether and extraction with dilute sodium hydroxide aqueous solution. The acid that precipitated during the acidification was recrystallized from dilute methanol to afford a pure product 1-diamantanecarboxylic acid. FIG. 5 shows the IR spectrum of 1-diamantanecarboxylic acid in which it was characterized by C═O stretching at 1687 cm⁻¹.

Step 3. Synthesis of sodium 1-diamantanecarboxylate from 1-diamantanecarboxylic acid

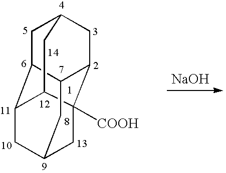

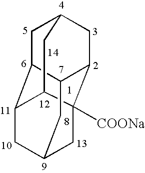

| Reagent | MW | Amount | Moles | Eq. |
|---|---|---|---|---|
| 1-Diamantanecarboxylic acid | 232.32 | 0.6395 | 2.75 mmol | 1.0 |
| | | g | | |
| NaOH Water Solution (0.1016 M) | 40.00 | 26.91 | 2.73 mmol | 1.0 |
| | | mL | | |
| Sodium 1-Diamantanecarboxylate | 254.30 | 0.7 g | | 1.0 |

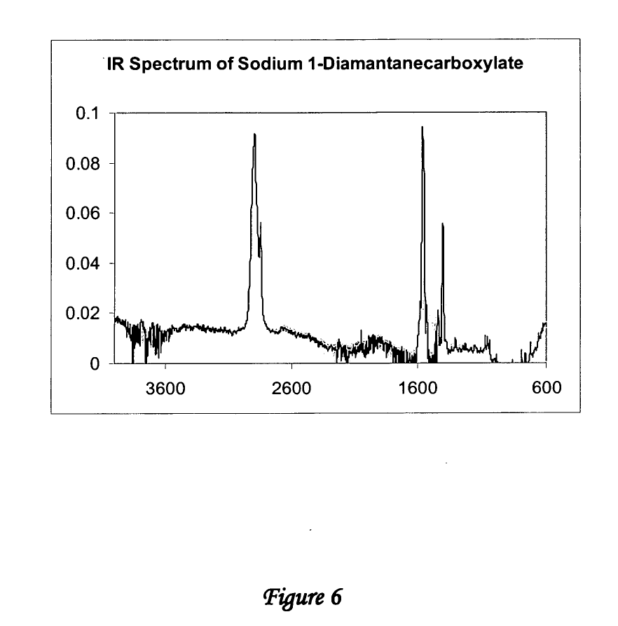

The desired amount of materials was weighed and loaded into a 100 mL round bottom flask. The mixture was stirred at room temperature under nitrogen for 16 hours. White solids precipitated with the evaporation of the major water solvent by rotovap to about 90% dryness. The mixture was cooled to room temperature and filtered under vacuum. The white solids were rinsed with 5 mL water once and then twice with 5 mL acetone (the product is very soluble in acetone) and air dried to collect 0.6507 g (92.9%). FIG. 6 shows the IR spectra of the sodium salt. In the sodium salt, the C═O stretch was shifted to about 1560 c⁻¹ from about 1687 cm⁻¹ in the acid.

### EXAMPLE 3

### Test of Diamondoid-Based Nucleator

Sodium-1-adamantanecarboxylate and sodium-1-diamantanecarboxylate, as well as sodium benzoate, a commonly used nucleating agent, were tested as polypropylene nucleating agents at concentrations of 200, 400, 800, and 1200 ppm. In addition, a sample without any nucleating agent, consisting of pure melted and crystallized polypropylene, was tested. The sodium-1-adamantanecarboxylate and sodium-1-diamantanecarboxylate were prepared by neutralization with caustic of mono-carboxylic acids, prepared from adamantane and diamantane. Alternatively, di- or tri-carboxylic acid salts could have been prepared. The nucleating agents were dissolved in ethanol and water and mixed with polypropylene. The mixtures, contained in 8-dram vials, were stirred and heating above the melting point of polypropylene (180-190° C.) to evaporate the ethanol and water and melt the polypropylene. Upon cooling, the polypropylene formed a solidified plug. The plug was removed and sampled at 5 different areas using Differential Scanning Calorimetry (DSC) to determine the T_{c} of the polypropylene melt during cooling. As higher values of T_{c} correspond to decreases in the amount of cooling time required for crystallization, values of T_{c} for polypropylene with an additive greater than the value of T_{c} for polypropylene without nucleating agent indicate effectiveness of the additive as a nucleating agent.

Table 2 contains DSC results for polypropylene without nucleating agent and polypropylene with sodium benzoate (NaOBz), sodium-1-adamantanecarboxylate (S-1-A), and sodium-1-diamantanecarboxylate (S-1-D), at various concentrations.

TABLE 2

| Nucleating | Concentration | Tᵣ (° C.) | No. of | Avg. T_{c} (° C.) | T_{c} (%) | (° C.) | T_{c} − Tᵣ |
|---|---|---|---|---|---|---|---|
| Agent | (ppm) | (note c) | Runs | (note d) | Std dev. | Std dev. | (° C.) |
| None | 0 | 118.56 | 7 | 118.56 | 1.2 | 1.38 | |
| Na Benzoate | 200 | 118.56 | 5 | 122.50 | 0.4 | 0.53 | 3.94 |
| Na Benzoate | 400 | 118.56 | 3 | 122.63 | 0.7 | 0.80 | 4.07 |
| Na Benzoate | 800 | 118.56 | 5 | 125.46 | 0.9 | 1.10 | 6.90 |
| S-1-A (note a) | 200 | 118.56 | 5 | 118.94 | 0.8 | 0.99 | 0.38 |
| S-1-A | 400 | 118.56 | 5 | 118.38 | 0.9 | 1.09 | −0.18 |
| S-1-A | 800 | 118.56 | 5 | 118.76 | 1.3 | 1.53 | 0.20 |
| S-1-A | 1600 | 111.90 | 3 | 113.60 | 0.3 | 0.28 | 1.70 |
| S-1-A | 3200 | 111.90 | 3 | 116.20 | 0.9 | 1.05 | 4.30 |
| S-1-A | 6400 | 111.90 | 3 | 116.90 | 1.6 | 1.91 | 5.00 |
| S-1-D (note b) | 200 | 118.56 | 5 | 127.18 | 0.5 | 0.64 | 8.62 |
| S-1-D | 400 | 118.56 | 5 | 128.44 | 0.4 | 0.46 | 9.88 |
| S-1-D | 800 | 118.56 | 5 | 128.78 | 1.0 | 1.22 | 10.22 |

(note a) Sodium 1-adamantanecarboxylate
(note b) Sodium 1-diamanatanecarboxylate
(note c) Crystallization temperature of polypropylene without the addition of a nucleating agent
(note d) Crystallization temperature of polypropylene with the addition of a nucleating agent

According to the DSC data of Table 2, the following conclusions are made. The crystallization temperature of pure polypropylene (Tr) depends on the calibration of the DSC instrument. The nucleator effect, (Tc−Tr), is quantified by the difference of the crystallization temperature of polypropylene with nucleator added (Tc) and the crystallization temperature of pure polypropylene (Tr). This quantity is independent of DSC instrument calibration. Sodium-1-adamantanecarboxylate showed minimal effect at low dose rates and a 5° C. effect at 6400 ppm. Sodium benzoate showed a nucleator effect over all dose rates tested. Sodium-1-diamantanecarboxylate showed a higher nucleator effect at lower dose rates than the others tested. A comparison of the three nucleating agent shows that in all cases that higher concentrations of nucleator results in larger values of nucleator effect (Tc−Tr).

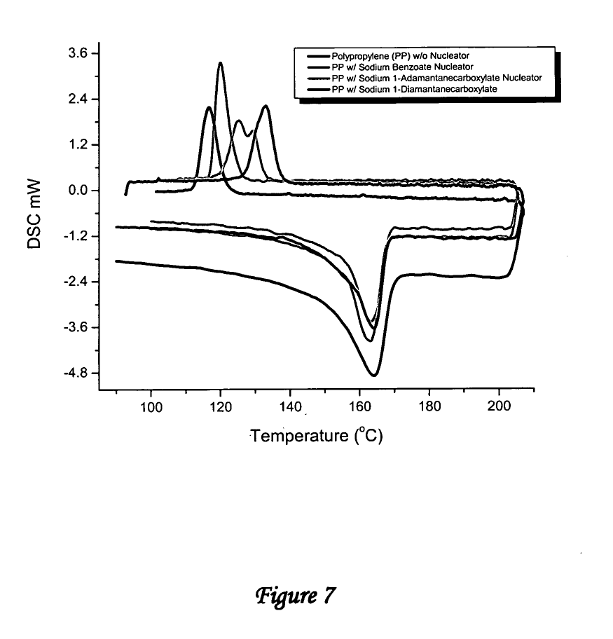

Accordingly, FIG. 7 shows DSC scan results for polypropylene without nucleating agent, polypropylene containing 1200 ppm sodium benzoate, polypropylene containing 1200 ppm sodium-1-adamantanecarboxylate, and polypropylene containing 1200 ppm sodium-1-diamantanecarboxylate. As can be seen from FIG. 7, polypropylene without nucleating agent provided the lowest T_{c}, with both sodium-1-adamantanecarboxylate and sodium-1-diamantanecarboxylate providing higher values of T_{c} than sodium benzoate.

### EXAMPLE 4

### Effect of Diamondoid-Based Nucleating Agents on Crystallization Behavior of Semi-Crystalline Polymers

Sample Preparation

The polymer composites with nucleating agents were mixed together using a DACA Micro extruder. The samples (4 gm to 4.5 gm) were inserted into the extruder and mixed for 3 min at a rotor speed of 100 rpm. The mixing temperatures of the polymers were: polypropylene: 220° C.; polyester (PET): 270° C.; Nylon 6: 250° C.; MXD6: 260° C. The extruded samples were tested using DSC to determine crystallization temperatures.

DSC Experiments

The DSC analyses of the composites were measured using a Mettler Toledo DSC822^{e} Module. Samples (10-15 mg) were tested at a heating/cooling rate of 10° C./min. The polypropylene composites were heated up to 230° C. dynamically and kept at 230° C. for 5 min and then cooled down to 40° C. Other polymer composites (PET, Nylons) were tested in the range of 40° C. to 300° C. at the same heating rate of 10° C./min.

TABLE 3
Description of Nucleating Agents Tested

| Name of Nucleating | | | |
|---|---|---|---|
| Agent | Structure | Formula | M.W. |
| Lithium 1- Adamantanecarboxylate | 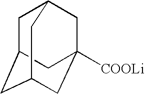 | C₁₁H₁₅O₂Li | 186.18 |
| Sodium 1- Adamantanecarboxylate | 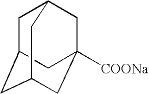 | C₁₁H₁₅O₂Na | 202.23 |
| Potassium 1- Adamantanecarboxylate | 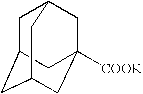 | C₁₁H₁₅O₂K | 218.34 |
| Magnesium 1- Adamantanecarboxylate | 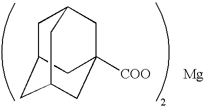 | C₂₂H₃₀O₄Mg | 382.79 |
| Calcium 1- Adamantanecarboxylate | 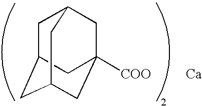 | C₂₂H₃₀O₄_{Ca} | 398.56 |
| Strontium 1- Adamantanecarboxylate | 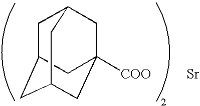 | C₂₂H₃₀O₄Sr | 446.10 |
| Sodium 1,3- Adamantane- dicarboxylate | 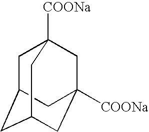 | C₁₂H₁₄O₄Na₂ | 268.22 |
| Sodium 1- Diamantanecarboxylate | 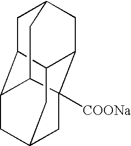 | C₁₅H₁₉O₂Na | 254.30 |
| Sodium 1,6-diamantane dicarboxylate | 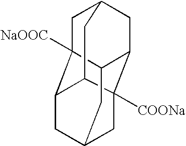 | C₁₆H₁₈O₄Na₂ | 320.12 |

TABLE 4
Polypropylene composites - Effect of diamondoid nucleating agents on
crystallization temperature (T_{c}; ° C.). The Tc of PP pellet
(as received from Dow) was 115° C.

| | T_{c} at | T_{c} at | T_{c} at |
|---|---|---|---|
| Nucleating agents | 0.0 wt % | 0.1 wt % | 0.5 wt % |
| Lithium 1- | 115 | 115 | 115 |
| Adamantanecarboxylate | | | |
| Sodium 1- | 115 | 120 | 125 |
| Adamantanecarboxylate | | | |
| Potassium 1- | 115 | 120 | 124 |
| Adamantanecarboxylate | | | |
| Magnesium 1- | 115 | 121 | 126 |
| Adamantanecarboxylate | | | |
| Calcium 1- | 115 | 120 | 124 |
| Adamantanecarboxylate | | | |
| Strontium 1- | 115 | 117 | 116 |
| Adamantanecarboxylate | | | |
| Sodium 1,3- | 115 | 125 | 128 |
| Adamantanedicarboxylate | | | |
| Sodium 1- | 115 | 115 | 118 |
| Diamantanecarboxylate | | | |
| Sodium 1,6-diamantanedicarboxylate | 115 | 116 | 119 |

TABLE 5
PET composites - Effect of diamondoid nucleating agents on
crystallization temperature (T_{c}). The Tc of PET pellet
(as received from KoSa) was 203° C.

| | T_{c} at | T_{c} at | T_{c} at |
|---|---|---|---|
| Nucleating agents | 0.0 wt % | 0.1 wt % | 0.5 wt % |
| Lithium 1- | 207 | 211 | 209 |
| Adamantanecarboxylate | | | |
| Sodium 1- | 207 | 211 | 219 |
| Adamantanecarboxylate | | | |
| Potassium 1- | 207 | 209 | 207 |
| Adamantanecarboxylate | | | |
| Magnesium 1- | 207 | 212 | 212 |
| Adamantanecarboxylate | | | |
| Calcium 1- | 207 | 212 | 211 |
| Adamantanecarboxylate | | | |
| Strontium 1- | 207 | 213 | 213 |
| Adamantanecarboxylate | | | |
| Sodium 1,3- | 207 | 209 | 218 |
| Adamantanedicarboxylate | | | |
| Sodium 1- | 207 | 212 | 217 |
| Diamantanecarboxylate | | | |
| Sodium 1,6-diamantanedicarboxylate | 207 | 212 | 217 |

TABLE 6
Ultramid (Nylon 6) composites - Effect of diamondoid nucleating
agents on crystallization temperature (T_{c}). The Tc of PET
pellet (as received from KoSa) was 181° C.

| | T_{c} at | T_{c} at | T_{c} at |
|---|---|---|---|
| Nucleating agents | 0.0 wt % | 0.1 wt % | 0.5 wt % |
| Lithium 1- | 183 | 189 | 185 |
| Adamantanecarboxylate | | | |
| Sodium 1- | 183 | 186 | 185 |
| Adamantanecarboxylate | | | |
| Potassium 1- | 183 | — | 188 |
| Adamantanecarboxylate | | | |
| Magnesium 1- | 183 | — | 185 |
| Adamantanecarboxylate | | | |
| Calcium 1- | 183 | — | 186 |
| Adamantanecarboxylate | | | |
| Strontium 1- | 183 | — | 185 |
| Adamantanecarboxylate | | | |
| Sodium 1,3- | 183 | — | 184 |
| Adamantanedicarboxylate | | | |
| Sodium 1- | 183 | — | 184 |
| Diamantanecarboxylate | | | |
| Sodium 1,6-diamantanedicarboxylate | 183 | — | 181 |

TABLE 7
Nylon MXD6 composites - Effect of diamondoid nucleating
agents of crystallization temperature (T_{c})

| | T_{c} at | | |
|---|---|---|---|
| Nucleating agents | 0.0 wt % | T_{c} at 0.1 wt % | T_{c} at 0.5 wt % |
| Lithium 1- | 190 | — | 189 |
| Adamantanecarboxylate | | | |
| Sodium 1- | 190 | — | 183 (Generates |
| Adamantanecarboxylate | | | pinkish color) |

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A composition comprising a thermoplastic and a diamondoid-containing nucleating agent.

2. The composition of claim 1 wherein the diamondoid-containing nucleating agent comprises a diamondoid having at least one pendant functional group.

3. The composition of claim 1 wherein the diamondoid-containing nucleating agent comprises adamantane, diamantane or triamantane.

4. The composition of claim 1 wherein the diamondoid-containing nucleating agent comprises adamantane having at least one pendant functional group, diamantane having at least one pendant functional group, or triamantane having at least one pendant functional group.

5. The composition of claim 1 wherein the diamondoid-containing nucleating agent comprises adamantane having at least one pendant hydroxyl or carboxyl group, diamantane having at least one pendant hydroxyl or carboxyl group, or triamantane having at least one pendant hydroxyl or carboxyl group.

6. The composition of claim 1 wherein the diamondoid-containing nucleating agent comprises a higher diamondoid.

7. The composition of claim 6 wherein the diamondoid-containing nucleating agent comprises a higher diamondoid having at least one pendant functional group.

8. The composition of claim 1 wherein the diamondoid-containing nucleating agent comprises a compound having one, two or three diamondoid moieties.

9. The composition of claim 8 wherein the diamondoid moiety is an adamantane, diamantane or triamantane moiety.

10. The composition of claim 9 wherein the adamantane, diamantane or triamantane moiety has at least one functional group.

11. The composition of claim 10 wherein the functional group is a hydroxyl or carboxyl group.

12. The composition of claim 1, wherein the thermoplastic is selected from the group consisting of polyethylene, polypropylene, nylon, polyethylene terephthalate, polylactic acid, polyethylene nathphlate and combinations thereof.

13. The composition of claim 5, wherein the diamondoid derivatives are diamondoid carboxylate salts of Group I or Group II metals.

14. The composition of claim 13, wherein the diamondoid derivative is sodium-1-adamantanecarboxylate.

15. The composition of claim 13, wherein the diamondoid derivative is sodium-1-diamantanecarboxylate.

16. The composition of claim 1 which optionally comprises a plasticizer, a filler, a reinforcing agent, an antioxidant, a thermal stabilizer, a UV stabilizer, a flame retardant, a colorant or an antistatic agent.

17. A process for preparing a thermoplastic composition comprising uniformly dispersing a diamondoid-containing nucleating agent in a thermoplastic composition.

18. The process of claim 17 wherein the diamondoid-containing nucleating agent is added in an amount effective to raise the thermoplastic crystallization temperature.

19. The process of claim 17 wherein the diamondoid-containing nucleating agent is added in an amount effective to increase the crystallization rate of the thermoplastic.

20. The process of claim 17 wherein the diamondoid-containing nucleating agent is added in an amount effective to provide the thermoplastic with higher clarity.

21. The process of claim 17 wherein the diamondoid-containing nucleating agent is added in an amount effective to provide the thermoplastic with greater rigidity.

22. The process of claim 17 wherein the diamondoid-containing nucleating agent is added in an amount effective to provide the thermoplastic with higher temperature resistance.

23. A process for manufacturing a molded article comprising uniformly dispersing a diamondoid-containing nucleating agent in a thermoplastic composition, thereafter melting the thermoplastic composition, and forming the melted thermoplastic composition into a molded article.

24. The process of claim 23 wherein the diamondoid-containing nucleating agent is added in an amount effective to raise the thermoplastic crystallization temperature.

25. The process of claim 23 wherein the diamondoid-containing nucleating agent is added in an amount effective to increase the crystallization rate of the thermoplastic.

26. The process of claim 23 wherein the diamondoid-containing nucleating agent is added in an amount effective to provide the thermoplastic with higher clarity.

27. The process of claim 23 wherein the diamondoid-containing nucleating agent is added in an amount effective to provide the thermoplastic with greater rigidity.

28. The process of claim 23 wherein the diamondoid-containing nucleating agent is added in an amount effective to provide the thermoplastic with higher temperature resistance.

29. The process of claim 17, wherein about 10 ppmw to 10 weight % of the diamondoid-containing nucleating agent is added to the thermoplastic composition.

30. The process of claim 23, wherein about 10 ppmw to 10 weight % of the diamondoid-containing nucleating agent is added to the thermoplastic composition.

31. An article comprising the composition of claim 1.

32. The article of claim 31, wherein the article is a molded article selected from the group consisting of storage containers, medical devices, food packages, plastic tubes and pipes, and shelving units.

33. The article of claim 31, wherein the article is a thermoplastic film.

34. The article of claim 31, wherein the article exhibits improved performance characteristics as compared to an article without any nucleating agent.
